(19) United States
(12) Patent Application Publication
(10) Pub. No.: US 2025/0214208 A1
(43) Pub. Date: Jul. 3, 2025

(54) SCREWDRIVER

(71) Applicant: YEH-CHING CHANG, Taichung City (TW)

(72) Inventors: YEH-CHING CHANG, Taichung City (TW); CHIEN-CHANG HUANG, Taichung City (TW)

(21) Appl. No.: 18/920,628

(22) Filed: Oct. 18, 2024

(30) Foreign Application Priority Data
Dec. 29, 2023 (TW) 112214371

(51) Int. Cl. B25B 15/00; B25G 1/08

(52) U.S. Cl. CPC B25B 15/00; B25G 1/085

(57) ABSTRACT

A screwdriver includes a handle, a fixed stem, a storage assembly and an engaging mechanism. The handle includes a housing defining an inner space. The fixed stem defines an axial direction and is disposed on the housing and protrudes into the inner space. The storage assembly includes a movable stem and at least one storage seat disposed on the movable stem, and the movable stem is movably sleeved with the fixed stem. The engaging mechanism includes at least one first engaging portion disposed on the fixed stem, a second engaging portion disposed on the movable stem and a release assembly. The release assembly is operatable to abut against the second engaging portion so that the second engaging portion is disengaged from said first engaging portion, and the storage assembly is detachable from the fixed stem and removable from the handle.

### BACKGROUND OF THE INVENTION

### Field of the Invention

The present invention relates to a screwdriver.

### Description of the Prior Art

A screwdriver is used to rotate fasteners for mounting an object. A conventional screwdriver is used with sockets or tool heads according to types of the fasteners to be rotated so as to be convenient to use and have a wide range of applications. For storage and carrying the sockets and tool heads, a storage device or a tool handle with storage functions has been developed and provided. However, the conventional tool handle with storage functions has insufficient storage space and can only accommodate sockets and tool heads of specified specifications, which is inconvenient to use.

The present invention is, therefore, arisen to obviate or at least mitigate the above-mentioned disadvantages.

### SUMMARY OF THE INVENTION

The main object of the present invention is to provide a screwdriver, which has a storage seat being detachable and changeable.

To achieve the above and other objects, the present invention provides a screwdriver, including: a handle, a fixed stem, a storage assembly and an engaging mechanism. The handle includes a housing, and the housing defines an inner space. The fixed stem defines an axial direction and is disposed on the housing and protrudes into the inner space. The storage assembly includes a movable stem and at least one storage seat disposed on the movable stem, and the movable stem is sleeved with the fixed stem and is movable relative to the fixed stem between an access position and a storage position. The engaging mechanism includes at least one first engaging portion disposed on the fixed stem, a second engaging portion disposed on the movable stem and a release assembly, and at least a portion of the release assembly is movable relative to the second engaging portion. When the movable stem is in the access position, the second engaging portion is engaged with the at least one first engaging portion, the at least one storage seat is located out of the inner space, the release assembly is configured to be operated and abutted against the second engaging portion so that the second engaging portion is disengaged from the at least one first engaging portion, and the storage assembly is detachable from the fixed stem and removable from the handle

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of a preferable embodiment of the present invention;

FIG. 3 is a cross-sectional view of a preferable embodiment of the present invention when a movable stem is in a storage position;

FIGS. 4 and 5 are drawings showing operation according to a preferable embodiment of the present invention when the movable stem is moving to an access position;

FIG. 6 is an enlargement of FIG. 5;

FIG. 7 is a partial cross-sectional view of a preferable embodiment of the present invention when the movable stem is in the access position;

FIGS. 8-10 are drawings showing operation of a release assembly according to a preferable embodiment of the present invention; and

FIG. 11 is a stereogram of a preferable embodiment of the present invention when a storage assembly is detached from a handle.

### DETAILED DESCRIPTION OF THE PREFERRED EMBODIMENTS

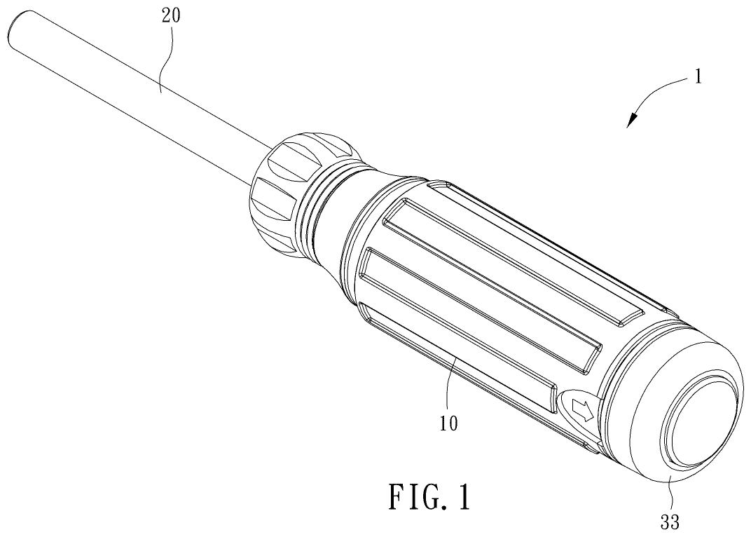

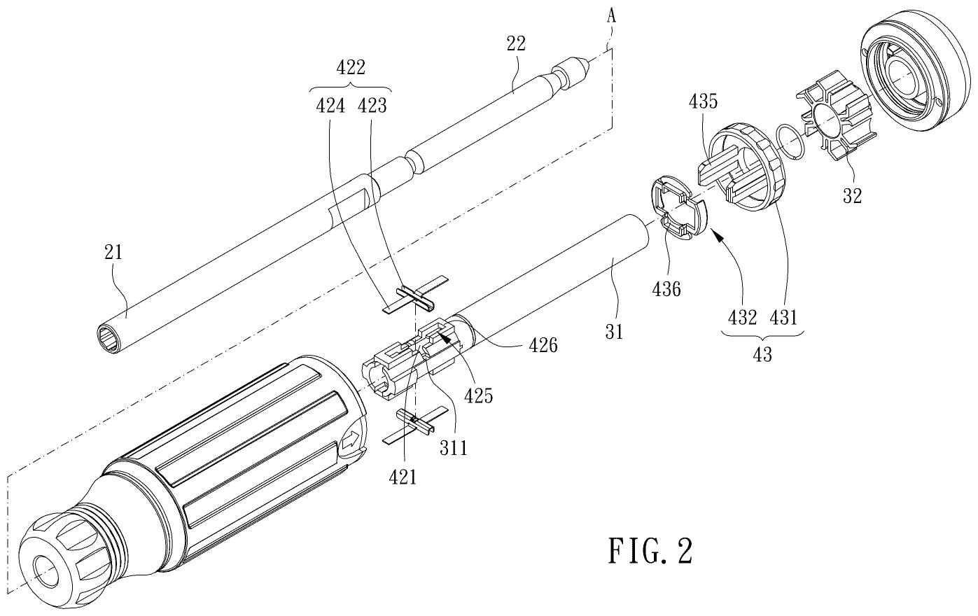

Please refer to FIGS. 1 to 11 for a preferable embodiment of the present invention. A screwdriver 1 of the present invention includes a handle 10, a fixed stem 20, a storage assembly 30 and an engaging mechanism 40.

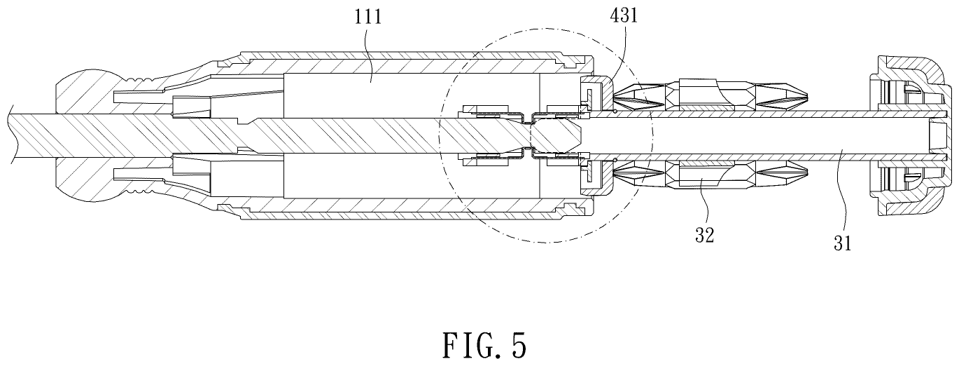

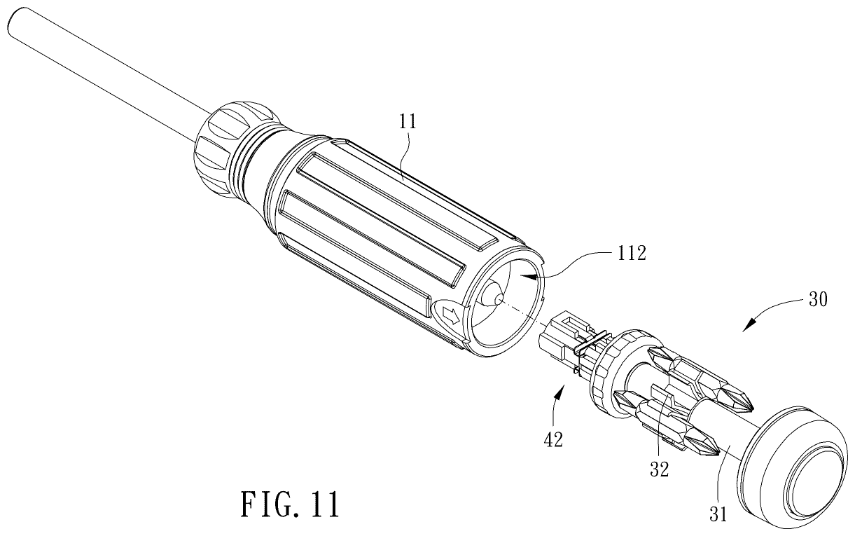

The handle 10 includes a housing 11, and the housing 11 defines an inner space 111. The fixed stem 20 defines an axial direction A and is disposed on the housing 11 and protrudes into the inner space 111. The storage assembly 30 includes a movable stem 31 and at least one storage seat 32 disposed on the movable stem 31, and the movable stem 31 is sleeved with the fixed stem 20 and is movable relative to the fixed stem 20 between an access position and a storage position. The engaging mechanism 40 includes at least one first engaging portion 41 disposed on the fixed stem 20, a second engaging portion 42 disposed on the movable stem 31 and a release assembly 43, and at least a portion of the release assembly 43 is movable relative to the second engaging portion 42. When the movable stem 31 is in the access position, the second engaging portion 42 is engaged with the at least one first engaging portion 41, and the at least one storage seat 32 is located out of the inner space 111, as shown in FIG. 5. At this time, the release assembly 43 is configured to be operated and abutted against the second engaging portion 42 so that the second engaging portion 42 is disengaged from the first engaging portion 41, and the storage assembly 30 is detachable from the fixed stem 20 and removable from the handle 10, as shown in FIG. 11. Therefore, the storage seat 32 can be provided in different specifications to accommodate different types or sizes of tool heads or sockets, which is convenient to use.

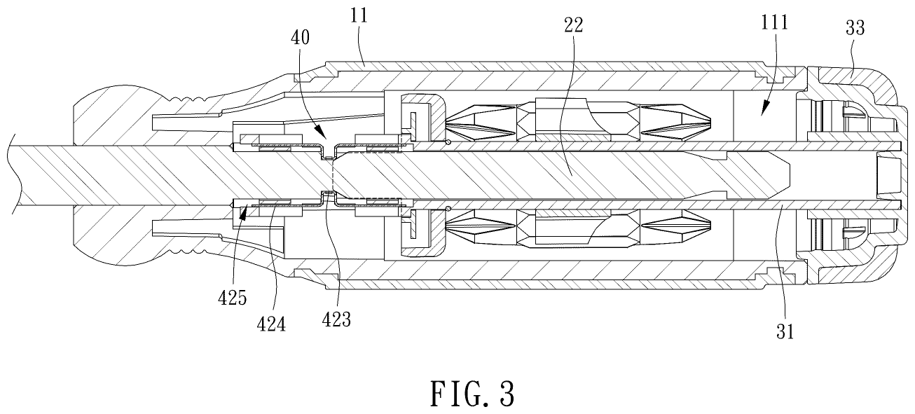

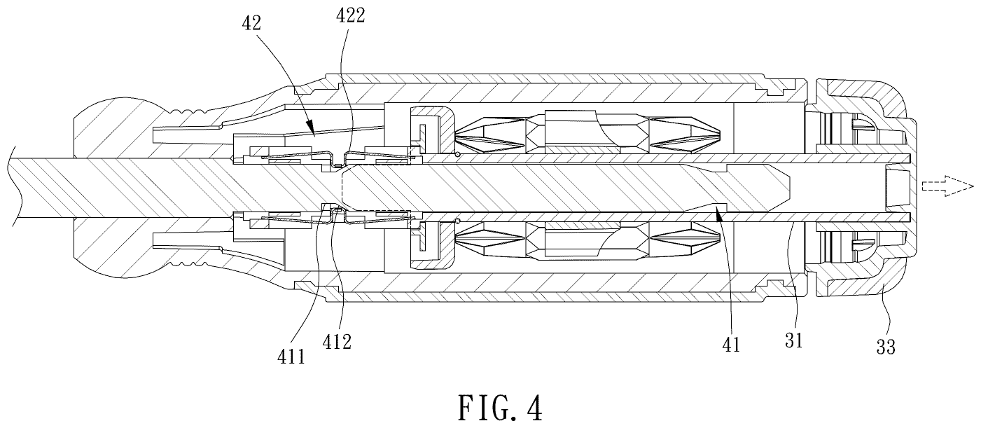

The fixed stem 20 includes a driving end 21 protruding out of the housing 11 and a connecting end 22 protruding into the inner space 111, and a side of the housing 11 remote from the driving end 21 includes an end opening 112 communicated with the inner space 111. The storage assembly 30 further includes a cover body 33 connected with an end of the movable stem 31 and covering the end opening 112 so that the storage seat 32 can be completely accommodate in the housing 11, as shown in FIG. 3, to prevent the storage seat 32 from being exposed outwardly. The driving end 21 is configured for a tool head socket to be assembled thereon, and the movable stem 31 is sleeved to the connecting end 22 and is movable relative to the fixed stem 20 in the axial direction A. In this embodiment, the fixed stem 20 includes two said first engaging portions 41 spaced apart from each other in the axial direction A, and each of the two said first engaging portion 41 includes an annular recess 411 and a first inclined surface 412 adjacent to the annular recess 411. When the movable stem 31 is moved between the access position and the storage position, the second engaging portion 42 is engaged within or disengaged from one said annular recess 411 along one said first inclined surface 412 for positioning and smooth operation, as shown in FIG. 4. In other embodiments, the screwdriver may further has a driving stem mounted to the housing; the fixed stem may have only one said first engaging portion disposed thereon.

The second engaging portion 42 includes at least one through hole 421 radially extending through the movable stem 31 and at least one elastic member 422, and the at least one elastic member 422 is protrudable beyond an inner circumferential surface of the movable stem 31 via the at least one through hole 421 and engaged within the at least one first engaging portion 41 so that the movable stem 31 is positioned in the access position or the storage position. Specifically, each of the at least one elastic member 422 includes a restricting portion 423 at least partially received within one said through hole 421 and two elastic arms 424 located at two opposite sides of the restricting portion 423, the second engaging portion 42 further includes at least two receiving portions 425 located at two opposite sides of one said through hole 421, and each of the two elastic arms 424 is engaged within one of the at least two receiving portions 425 to avoid displacement and be easy to be assembled. The movable stem 31 has at least two engaging grooves 311 located at two opposite sides of one said through hole 421, and the restricting portion 423 of each said elastic member 422 is disposed across and between two said engaging grooves 311 and protrudes beyond a side of each of the two said engaging grooves 311 opposite to one said through hole 421. Therefore, each said restricting portion 423 is engaged within one said annular recess 411 through one said through hole 421, and the two elastic arms 424 of each said elastic member 422 make one said restricting portion 423 have a tendency to move in a direction radially toward the fixed stem 20 and allow the said restricting portion 423 to be moved in a direction remote from one said annular recess 411 for release. In this embodiment, each said elastic member 422 is a metal elastic piece which is bent and formed in one piece, and each said restricting portion 423 has a U-shaped cross-sectional profile which is concave toward one said through hole 421 so as to provide a simple structure, appropriate strength and stable engagement.

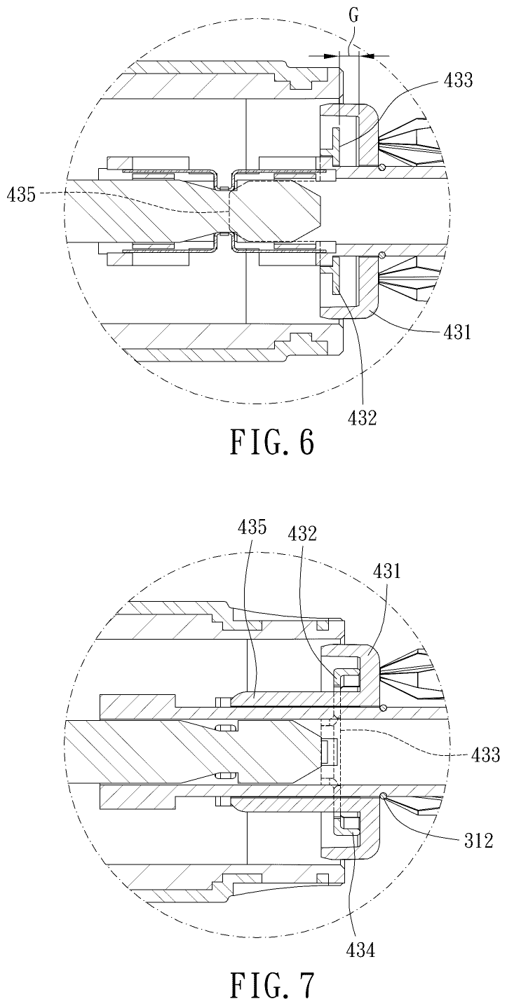

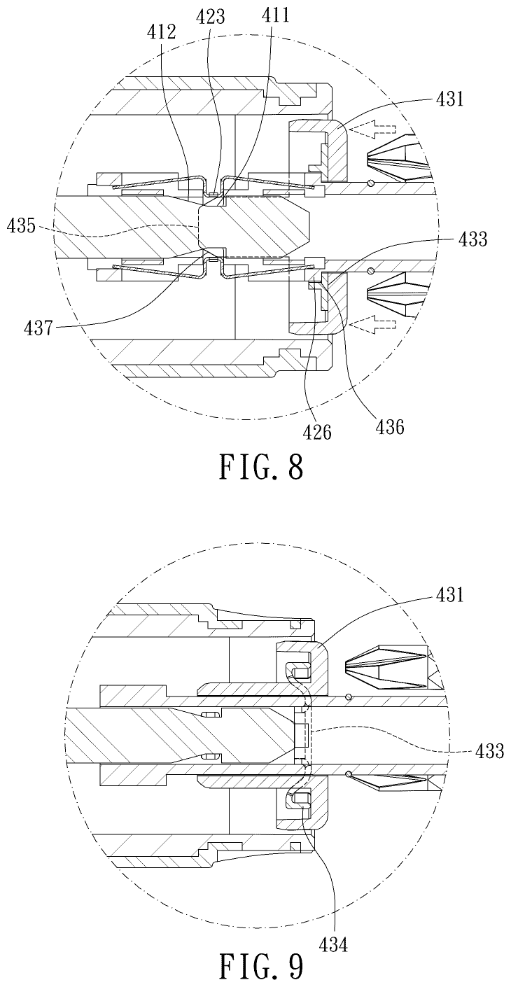

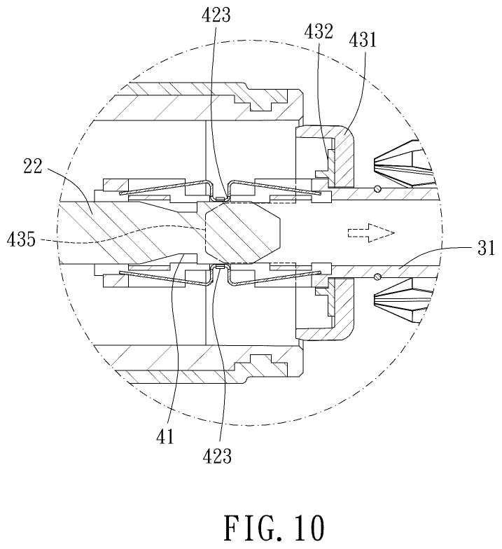

Moreover, the release assembly 43 includes a push member 431 being abuttable against the second engaging portion 42 and a first restricting member 432 located between the push member 431 and the second engaging portion 42. The first restricting member 432 includes a side surface 433 extending in a direction lateral to the axial direction A and facing toward the push member 431, and the side surface 433 and the push member 431 normally have an interval G, as shown in FIGS. 6 and 7. Specifically, the first restricting member 432 further includes two blocking protrusions 434 located at two radially opposite sides of the movable stem 31 and protruding beyond the side surface 433, and the two blocking protrusions 434 are abutted against the push member 431 in the axial direction A. The movable stem 31 has a second restricting member 312 (such as an annular retainer) radially protruding therefrom, and the second restricting member 312 is blocked between the storage seat 32 and the release assembly 43 in the axial direction A so as to maintain the interval G and position the push member 431. When the movable stem 31 is in the access position, at least a portion of the push member 431 is located out of the inner space 111 so that the push member 431 is operable externally. A side of the push member 431 facing toward the second engaging portion 42 has at least one push arm 435 extending in the axial direction A. When the push member 431 is moved toward the second engaging portion 42, the at least one push arm 435 urges the at least one elastic member 422 to elastically deform and disengage from the at least one first engaging portion 41. Please refer to FIGS. 8 and 9, when the push member 431 is pushed in a direction toward the second engaging portion 42, the push member 431 urges the first restricting member 432 to elastically deform, the push member 431 is moved toward the second engaging portion 42 and contacts the side surface 433, and the at least one push arm 435 urges the at least one elastic member 422 to be disengaged from one said annular recess 411. Therefore, the movable stem 31 is detachable from the fixed stem 20 in a direction remote from the housing 11, and the storage assembly 30 is replaceable, as shown in FIGS. 10 and 11.

Preferably, in the axial direction A, the interval G is larger than or equal to a width of one of the at least two engaging grooves 311 so that the at least one push arm 435 can effectively push each said restricting portion 423 to move radially outward. One of the second engaging portion 42 and the first restricting member 432 further includes at least one convex portion 426, and the other of the second engaging portion 42 and the first restricting member 432 further includes at least one concave portion 436 non-rotatably engaged with the at least one convex portion 426, and the push member 431 is partially and non-rotatably disposed through the first restricting member 432 so as to prevent the release assembly 43 from being rotated relative to the movable stem 31, which has a simple structure and is easy to be assembled. The at least one convex portion 426 is blockable with the at least one concave portion 436 in the axial direction A so as to limit a distance that the push member 431 moves toward the second engaging portion 42. The first restricting member 432 may be made of rubber, plastics or other elastic materials, which allows the first restricting member 432 to elastically deform when being pushed, and drive the push member 431 to move to its original position when no force is applied.

In this embodiment, the second engaging portion 42 includes two said through holes 421 radially opposite to each other and two said elastic members 422, and the push member 431 includes two said push arms 435 parallel to each other and located at two opposite sides of the movable stem 31 so as to have stable engagement and operation. Each of the two said push arms 435 is movable between the two said elastic members 422 and includes two second inclined surfaces 437 facing toward the two said elastic members 422, and an inclined direction of each of said second inclined surfaces 437 is opposite to an inclined direction of one said first inclined surface 412 close to the end opening 112 so that each of the two said push arms 435 is smoothly moved between two said restricting portions 423.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A screwdriver, including:
a handle, including a housing, the housing defining an inner space;
a fixed stem, defining an axial direction, disposed on the housing and protruding into the inner space;
a storage assembly, including a movable stem and at least one storage seat disposed on the movable stem, the movable stem sleeved with the fixed stem and being movable relative to the fixed stem between an access position and a storage position; and
an engaging mechanism, including at least one first engaging portion disposed on the fixed stem, a second engaging portion disposed on the movable stem and a release assembly, at least a portion of the release assembly being movable relative to the second engaging portion;
wherein when the movable stem is in the access position, the second engaging portion is engaged with the at least one first engaging portion, the at least one storage seat is located out of the inner space, the release assembly is configured to be operated and abutted against the second engaging portion so that the second engaging portion is disengaged from the at least one first engaging portion, and the storage assembly is detachable from the fixed stem and removable from the handle.

2. The screwdriver of claim 1, wherein the second engaging portion includes
at least one through hole radially extending through the movable stem and
at least one elastic member, the at least one elastic member is protrudable beyond an inner circumferential surface of the movable stem via the at least one through hole and engaged within the at least one first engaging portion so that the movable stem is positioned in the access position or the storage position.

3. The screwdriver of claim 2, wherein each of the at least one elastic member includes a restricting portion at least partially received within one said through hole and two elastic arms located at two opposite sides of the restricting portion, the second engaging portion further includes at least two receiving portions located at two opposite sides of one said through hole, and each of the two elastic arms is engaged within one of the at least two receiving portions.

4. The screwdriver of claim 2, wherein each of the at least one elastic member includes a restricting portion at least partially received within one said through hole, the movable stem has at least two engaging grooves located at two opposite sides of one said through hole, and the restricting portion of each said elastic member is disposed across and between two said engaging grooves and protrudes beyond a side of each of the two said engaging grooves opposite to one said through hole.

5. The screwdriver of claim 2, wherein the release assembly includes a push member being abuttable against the second engaging portion, a side of the push member facing toward the second engaging portion has at least one push arm extending in the axial direction; when the push member is moved toward the second engaging portion, the at least one push arm urges the at least one elastic member to elastically deform and disengaged from the at least one first engaging portion.

6. The screwdriver of claim 1, wherein the release assembly includes a push member being abuttable against the second engaging portion and a first restricting member located between the push member and the second engaging portion, one of the second engaging portion and the first restricting member includes at least one convex portion, the other of the second engaging portion and the first restricting member includes at least one concave portion non-rotatably engaged with the at least one convex portion, and the push member is partially and non-rotatably disposed through the first restricting member.

7. The screwdriver of claim 1, wherein the release assembly includes a push member being abuttable against the second engaging portion and a first restricting member located between the push member and the second engaging portion, the first restricting member includes a side surface extending in a direction lateral to the axial direction and facing toward the push member, the side surface and the push member normally have an interval therebetween; when the push member is pushed in a direction toward the second engaging portion, the push member urges the first restricting member to elastically deform, and the push member is moved toward the second engaging portion and contacts the side surface.

8. The screwdriver of claim 7, wherein the first restricting member further includes two blocking protrusions located at two radially opposite sides of the movable stem and protruding beyond the side surface, and the two blocking protrusions are abutted against the push member in the axial direction.

9. The screwdriver of claim 1, wherein the movable stem has a second restricting member radially protruding therefrom, and the second restricting member is blocked between the storage seat and the release assembly in the axial direction.

10. The screwdriver of claim 4, wherein each of the at least one elastic member further includes two elastic arms located at two opposite sides of the restricting portion, the second engaging portion further includes at least two receiving portions located at two opposite sides of one said through hole, and each of the two elastic arms is engaged within one of the at least two receiving portions; the fixed stem includes a driving end protruding out of the housing and a connecting end protruding into the inner space, a side of the housing remote from the driving end includes an end opening communicated with the inner space, the storage assembly further includes a cover body connected with an end of the movable stem and covering the end opening; the release assembly includes a push member being abuttable against the second engaging portion, a side of the push member facing toward the second engaging portion has at least one push arm extending in the axial direction; when the push member is moved toward the second engaging portion, the at least one push arm urges the at least one elastic member to elastically deform and disengage from the at least one first engaging portion; the fixed stem includes two said first engaging portions spaced apart from each other in the axial direction, each of the two said first engaging portions includes an annular recess and a first inclined surface adjacent to the annular recess; the second engaging portion includes two said through holes radially opposite to each other and two said elastic members, the push member includes two said push arms parallel to each other and located at two opposite sides of the movable stem; each of the two said push arms is movable between the two said elastic members and includes two second inclined surfaces facing toward the two said elastic members, an inclined direction of each of said second inclined surfaces is opposite to an inclined direction of one said first inclined surface close to the end opening; when the movable stem is in the access position, at least a portion of the push member is located out of the inner space; the release assembly further includes a first restricting member located between the push member and the second engaging portion, one of the second engaging portion and the first restricting member includes at least one convex portion, the other of the second engaging portion and the first restricting member includes at least one concave portion non-rotatably engaged with the at least one convex portion, and the push member is partially and non-rotatably disposed through the first restricting member; the at least one convex portion is blockable with the at least one concave portion in the axial direction; the first restricting member includes a side surface extending in a direction lateral to the axial direction and facing toward the push member, the side surface and the push member normally have an interval therebetween; in the axial direction, the interval is larger than or equal to a width of one of the at least two engaging grooves; when the push member is pushed in a direction toward the second engaging portion, the push member urges the first restricting member to elastically deform, and the push member is moved toward the second engaging portion and contacts the side surface; the first restricting member further includes two blocking protrusions located at two radially opposite sides of the movable stem and protruding beyond the side surface, and the two blocking protrusions are abutted against the push member in the axial direction; the movable stem has a second restricting member radially protruding therefrom, and the second restricting member is blocked between the storage seat and the release assembly in the axial direction; the second restricting member is an annular retainer; and each of the two said elastic members is a metal elastic piece which is bent and formed in one piece, and each said restricting portion has a U-shaped cross-sectional profile which is concave toward one of the two said through holes.
